(19) United States
(12) Patent Application Publication
(10) Pub. No.: US 2007/0162305 A1
(43) Pub. Date: Jul. 12, 2007

(54) ELECTRONIC MEDICAL INFORMATION EXCHANGE AND MANAGEMENT SYSTEM

(76) Inventor: Marc Jason Miller, Neenah, WI (US)

Correspondence Address: MAYER, BROWN, ROWE & MAW LLP, 71 S. WACKER, CHICAGO, IL, 60606, US

(21) Appl. No.: 11/619,950

(22) Filed: Jan. 4, 2007

Related U.S. Application Data
(60) Provisional application No. 60/756,015, filed on Jan. 4, 2006.
(60) Provisional application No. 60/762,676, filed on Jan. 27, 2006.

(51) Int. Cl. G06Q 10/00

(52) U.S. Cl. 705/2

(57) ABSTRACT

The present invention provides methods and systems to manage the exchange of medical information between two or more entities. Particularly, the present invention provides for computer-implemented systems and methods that are useful for transferring diagnostic medical examinations between hospitals, diagnostic imaging centers, medical clinics, physicians, physician groups, or entities employing physicians. The present invention further provides a method in which prospective consumers (e.g., hospitals, diagnostic imaging centers, and medical clinics) may engage the medical interpretation services of geographically dispersed providers (e.g., physicians, physician groups, or entities employing physicians).

### RELATED CASES

This application claims priority to U.S. Provisional Application Ser. No. 60/756,015 filed Jan. 4, 2006 and U.S. Provisional Application Ser. No. 60/762,676 filed Jan. 27, 2006, the entire contents of which are hereby incorporated by reference herein.

### BACKGROUND OF THE INVENTION

Traditionally, radiology studies were interpreted by radiologists in the hospital where the study was acquired. However, this began to change in the 1990s, when “teleradiology” was developed. Teleradiology is a means of electronically transmitting radiographic patient images and consultative text from one location to another. Thus, the development of teleradiology enabled the transmission of certain radiologic studies to radiologists at locations outside of the hospital. Further, teleradiology allowed radiologists to preliminarily assess a patient's radiologic study during the night and from the comfort of their homes.

Over the last decade, picture archive and communication systems (“PACS”) have become widespread in hospitals throughout the United States. These PACS coordinate all aspects of digital imaging in the hospital, diagnostic imaging center, or medical clinic. In particular, PACS capture images from Digital Imaging and Communication in Medicine (“DICOM”) compliant imaging modalities, non-DICOM compliant imaging modalities, and video sources; store this clinical information in a secure environment; and distribute and display both the clinical images and the corresponding diagnostic information throughout the hospital, diagnostic imaging center, or medical clinic. PACS also allow digital images (e.g., radiology studies) to be sent to radiologists' offices, other hospitals, and homes while maintaining the resolution and picture quality of the digital image. Consequently, because of the high quality of the digital images, radiologists can provide clinical diagnoses to the radiologic studies transmitted using PACS, and prepare final examination reports.

The development of teleradiology and PACS has given rise to the formation of companies, such as Nighthawk Radiology Services, which take advantage of these technological advances. (For ease of reference, such companies will be referred to hereafter as “Teleradiology Companies” when referring to multiple companies, and “a Teleradiology Company” when referring to one company.) Specifically, Teleradiology Companies employ radiologists and then offer their radiologists' services to hospitals, diagnostic imaging centers, and medical clinics. Hospitals, diagnostic imaging centers, and medical clinics contract directly with a Teleradiology Company to have their radiology studies interpreted for a fee. Once a contract has been executed, the radiology studies originating from the contracting hospital, diagnostic imaging center, or medical clinic are sent directly to the Teleradiology Company via an electronic transmission using PACS technology over the Internet, using wireless communication, or with a direct point to point link such as a T1 line. A Teleradiology Company's radiologist then reads the radiology study and sends a final examination report to the hospital, diagnostic imaging center, or medical clinic. Because of the versatility of the Internet, and the application of the PACS system, Teleradiology Companies can be located anywhere in the United States or in the world.

There is not, however, a central distribution center or marketplace where widely dispersed hospitals, diagnostic imaging centers, and medical clinics can temporarily and/or incidentally interact with, and contract with, health care providers like physicians, physician groups, or entities employing physicians for the interpretation of diagnostic examinations. Moreover, there is currently not a comprehensive system where radiology studies, or more generally, medical diagnostic examinations, from various geographically-dispersed facilities can be electronically transferred and posted at a virtual marketplace and contracted to many geographically-dispersed radiologists or radiology groups. Consequently, there is a need for a computer-implemented system for transferring medical diagnostic examinations in an electronic format through a virtual marketplace, to a geographically-dispersed group of physicians for medical interpretation.

### SUMMARY OF THE INVENTION

The present invention provides methods and systems to manage the exchange of medical information between two or more entities. Particularly, the present invention provides for computer-implemented systems and methods that are useful for transferring diagnostic medical examinations between hospitals, diagnostic imaging centers, medical clinics, physicians, physician groups, or entities employing physicians.

According to the preferred configuration, the system serves as a virtual marketplace allowing entities such as hospitals, diagnostic imaging centers, and medical clinics to electronically transfer diagnostic medical examinations such as imaging studies, electrocardiograms, and other electronic datasets of a diagnostic medical nature, to the virtual market. After the diagnostic medical examination is sent to the virtual marketplace, a description of the examination is posted at the virtual marketplace. A physician can then remotely review the description of the examination and decide whether he or she wants to interpret the examination. At the same time, the fee for the interpretation of the posted examination incrementally increases until either 1.) a physician decides to interpret the examination, 2.) a stop order is executed, or 3.) the ceiling price is reached. If a physician decides to interpret the examination, he or she contracts for the price of the examination's interpretation. The examination is subsequently routed to the contracting physician's location where it is reviewed and a medical interpretation is generated. Once completed, the medical interpretation is ultimately transferred to the hospital, diagnostic imaging center, or medical clinic that posted the examination at the virtual marketplace. Upon receipt of the interpretation, the entity that posted the examination is charged a fee for the interpretation. A portion of that fee is routed to the interpreting physician, and the remainder is retained by the virtual marketplace for the use of its service.

The present invention further provides a method in which prospective consumers (e.g., hospitals, diagnostic imaging centers, and medical clinics) may engage the medical interpretation services of geographically dispersed providers (e.g., physicians, physician groups, or entities employing physicians).

### BRIEF DESCRIPTION OF THE DRAWINGS

FIG. 1 is a block diagram of the virtual marketplace, according to the present invention;

FIG. 2 is a flow chart illustrating a hospital's role in the virtual marketplace; and

FIG. 3 is a flow chart illustrating a physician's role in the virtual marketplace.

### DETAILED DESCRIPTION OF THE PREFERRED EMBODIMENT

While the present invention is capable of being embodied in various forms, the description below of several embodiments is made with the understanding that the present disclosure is to be considered as an exemplification of the invention, and is not intended to limit the invention to the specific embodiments illustrated. Headings are provided for convenience only and are not to be construed to limit the invention in any way. Embodiments illustrated under any heading may be combined with embodiments illustrated under any other heading.

The Virtual Marketplace Overview

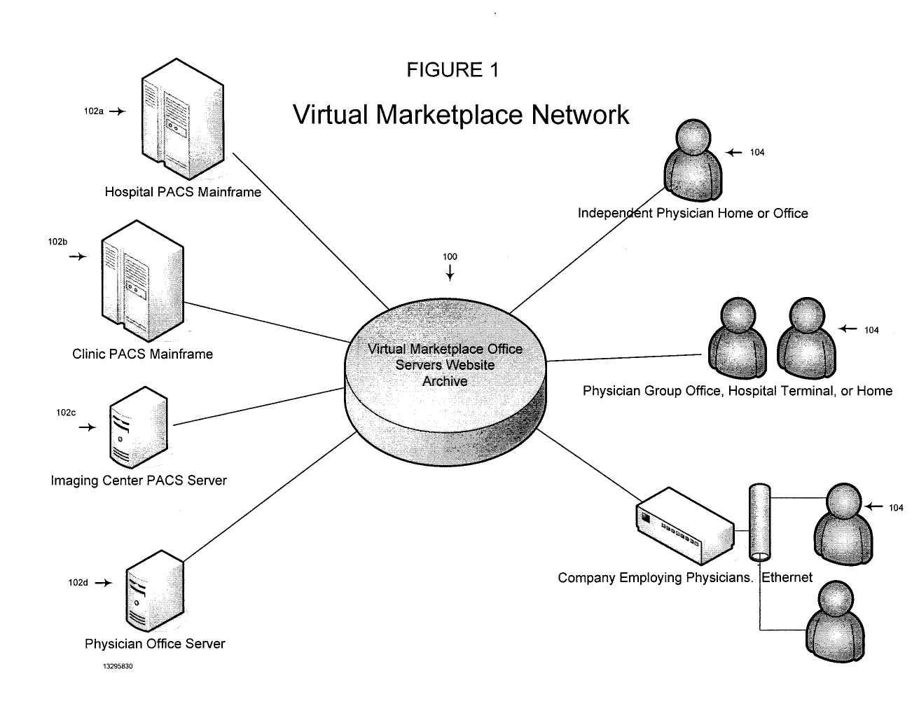

FIG. 1 is a block diagram of the virtual marketplace, according to an embodiment of the present invention. It is to be understood that the present invention provides for a computer-implemented system that allows medical diagnostic examinations to be posted by prospective consumers, such as but not limited to, hospitals 102a, medical clinics 102b, diagnostic imaging centers 102c, or physician offices 102d to a virtual marketplace 100 where they can then be reviewed and interpreted by physicians 104 located anywhere in the United States or abroad. Further, it is to be understood that the virtual marketplace may be advantageously accessible within a network, such as a local area network, a world-wide area network, or the Internet, in order to permit on-line access. On-line access is preferred as it enables hospitals 102a, medical clinics 102b, diagnostic imaging centers 102c, or physician offices 102d to post examinations to the virtual marketplace 100 where they can then be viewed, accessed, and/or downloaded by physicians 104 for interpretation.

Definitions

As used herein, “medical diagnostic imaging devices” include, but are not limited to, magnetic resonance imaging (“MRI”) equipment, ultrasound equipment, endoscopy equipment, X-ray, or computed tomography (“CT” or “CAT scan”) equipment.

As used herein, “medical diagnostic examination” or simply, “examination,” includes, but is not limited to, an image obtained from a medical diagnostic imaging device, an electroencephalogram (“EEG”), an electrocardiograph (“EKG” or “ECG”), an echocardiogram (“Echo”), a positron emission tomography scan (“PET scan”), a laboratory test, an electronic dataset of a diagnostic medical nature, an X-ray, or any other medical, dental, or ophthalmic test or data in which the result or information can be digitally transmitted. In addition, as used herein, “medical diagnostic examination” or “examination,” may include not only the complete examination, but also, information relevant to describing the examination, or a description of the examination.

As referred to herein, “physician” includes, but is not limited to, any medical doctor licensed in the United States or a foreign country to practice medicine (e.g., a radiologist, cardiologist, dentist, optometrist, osteopath, podiatrist, etc.).

As referred to herein, a “physician group” includes, but is not limited to, two or more medical doctors licensed in the United States or a foreign country to practice medicine.

As referred to herein, “primary entities” include, but are not limited to, hospitals, diagnostic imaging centers, and medical clinics. Further, a “primary entity” includes, but is not limited to, a hospital, a diagnostic imaging center, and a medical clinic.

As referred to herein, “secondary entities” include, but are not limited to, physicians, physician groups, or entities, including corporate entities employing physicians. Further, a “secondary entity” includes, but is not limited to, a physician, a physician group, or an entity employing physicians. In addition, “secondary entity” includes, but is not limited to, a physician or a physician group employed by the virtual marketplace.

As referred to herein, “virtual marketplace” or “marketplace” includes, but is not limited to, a website, a network site, a server, or an electronic database site whereby primary entities can post examinations or other electronic data and secondary entities can view the items that are posted and subsequently contract for the interpretation of these diagnostic medical examinations. A “virtual marketplace” or “marketplace” may also include the person, people, business, or entity that oversees the virtual marketplace.

As referred to herein, “post” includes, but is not limited to, sending or otherwise providing or granting access to examinations or other data in electronic format to the virtual marketplace.

Methods and Systems to Manage the Interpretation and Exchange of Medical Information

The present invention provides methods and systems to manage the exchange of medical information between two or more entities. It is contemplated that users accessing the system will be either primary entities and/or secondary entities. Primary entities will be those entities that are authorized to post medical diagnostic examinations at the virtual marketplace. Further, primary entities will, according to some embodiments, have the ability to search the credentials, performances, and quality rating reviews of the secondary entities. Secondary entities will have the ability to view, access, and download the medical diagnostic examinations at the virtual marketplace. A password system or a source terminal identification number may be utilized to verify the status and authenticity of the primary and secondary entities.

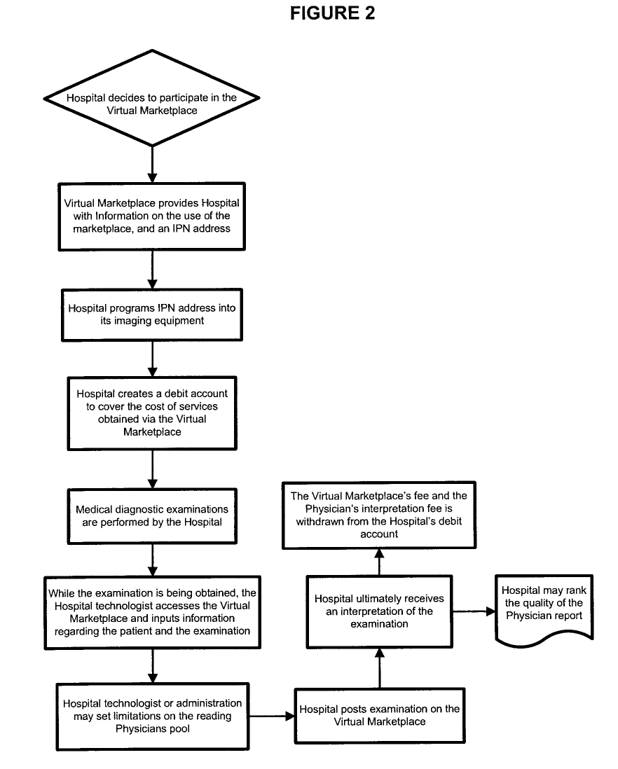

FIG. 2 depicts the steps and procedures a primary entity, such as a hospital, undertakes when using the virtual marketplace. Particularly, the primary entity contacts the virtual marketplace and informs the virtual marketplace that it would like to utilize the marketplace. The virtual marketplace then provides the primary entity, such as a hospital, with an Internet Protocol (“IP”) address The primary entity programs that IP address into its medical diagnostic imaging devices. This ensures the necessary linkage and communication, and that the examinations are properly sent to the virtual marketplace for posting.

In one embodiment, the primary entity also creates a debit account which contains sufficient funds to cover the physicians' interpretation services that will be acquired through use of the virtual marketplace. In another embodiment, the debit account, at a minimum, contains the physician's interpretation fee for the examination that the primary entity posts at the virtual marketplace. In the preferred embodiment, the debit account contains at least about four times the amount of the United States' Medicare reimbursement rate for the examination's interpretation that is posted at the virtual marketplace.

The primary entity then acquires examinations utilizing its existing medical diagnostic imaging devices, or any other device or method that produces examinations under the present invention. In one embodiment, the medical diagnostic imaging devices, or the other devices and methods that produce examinations, are all DICOM and HL7 compliant.

While the examination is being obtained, the physician, nurse, technologist, or other primary entity staff member who is assisting in the examination, accesses the virtual marketplace and inputs information about the patient and the examination. For example, information on the patient's identification and relevant medical history, reason for the examination, and imaging techniques can be inputted to the virtual marketplace.

In one embodiment, a primary entity may be presented with a patient information form to be filled out on-line when posting a medical diagnostic examination at the virtual marketplace. In another embodiment, the primary entity may upload and/or post a prepared patient information form to the virtual marketplace. When creating the patient information form on-line, a primary entity may respond to prompts to fill-in the required fields. The primary entity may also enter narrative about the patient or relevant information regarding the examination.

After the primary entity has completed the examination and the patient information form, it posts both items at the virtual marketplace. In yet another embodiment, the primary entity may simultaneously post multiple examinations and patient information forms at the virtual marketplace.

Patient privacy in transfer and posting is ensured through encryption. Further, all patient privacy legalities are addressed, and physician-patient privileges are upheld. The virtual marketplace maintains security practices and procedures that protect the privacy of the patients' medical information by limiting access only to authenticated primary and secondary entities.

Once at the virtual marketplace, the patient information form and the examination are electronically merged. In one embodiment, the patient information form will be seen as the first image in the medical diagnostic examination and will be used by a physician when he or she interprets the examination.

Before, during, or after posting, the virtual marketplace affords a primary entity the opportunity to set requirements and/or limitations on the secondary entities that may interpret the posted examination. For example, such requirements and/or limitations include, but are not limited to, a physician's level of training, fellowship experience, his or her states of medical licensure, and the virtual marketplace's rating of the physician. In another embodiment, the virtual marketplace also affords the primary entity the opportunity to control the duration of time in which the examination must be interpreted.

In yet another embodiment, the primary entity can require that only one specific physician can interpret the examination. In that instance, the virtual marketplace may send the designated physician a correspondence, such as an e-mail, voice message, text message, or pager notification informing him or her that an examination has been posted and is awaiting interpretation.

In another embodiment, the types of variables that are placed on the interpretation of the examination by the primary entity directly affect the cost. For example, if a primary entity needs an examination read within one hour, the cost of that examination's interpretation will be higher than an examination where the interpretation is needed within seven days. Similarly, as the level of a physician's experience increases, so does the cost for the examination's interpretation.

Once the patient information form and the examination are electronically merged at the virtual marketplace, and any and all requirements and/or limitations are placed on the examination's interpretation, the examination may be given an identification number by the virtual marketplace. This examination identification number will afford the primary entity, a secondary entity, and the virtual marketplace an easy way to locate and track the status of the examination at the marketplace.

In one embodiment, the virtual marketplace will electronically verify that the primary entity's debit account contains sufficient funds to cover the physician's interpretation fee of the posted examination. After the virtual marketplace confirms the existence of sufficient funds in the debit account, the virtual marketplace will allow the examination to be reviewed by a secondary entity, namely, a physician.

Prior to participation in the virtual marketplace, a physician's credentials will be reviewed and authenticated by the virtual marketplace. In one embodiment, the physician's credentials will be reviewed and authenticated using standard hospital credentialing that includes, but is not limited to, history of training, education, past or pending malpractice claims, proof of insurance, and a statement protecting patient privacy.

After a physician's credentials have been authenticated, he or she can begin using the virtual marketplace. When searching for a medical diagnostic examination to review, a physician may do one of at least the following three options.

First, a physician may review all of the examinations that are available for interpretation at the virtual marketplace in which he or she meets the primary entity's interpretation restrictions. A physician would just need to select the option at the virtual marketplace that enables him or her to view all the examinations that are currently posted on the marketplace and awaiting interpretation by someone of his or her skill set. If none of the examinations contain any interpretation restrictions, then the physician could view all of the examinations currently posted at the virtual marketplace.

Second, a physician could perform a search of all the examinations that are currently available for interpretation at the virtual marketplace using various search parameters. For example, search parameters may include, but are not limited to, fields such as: the type of digital image (e.g., MRI, CT, PET); the content of the image (e.g., brain, lungs, breast); the patient's description (e.g., male or female); or the fee received from the interpretation of the examination. These search parameters may be entered into a search box by the physician or, selected by the physician using various drop down menus. After completing a search, the physician will then be able to review all the examinations that matched his or her search parameters.

Third, a physician can review an examination by the examination's virtual marketplace identification number. Specifically, a physician can type the examination identification number in the examination identification number field, or perform a general search using that examination's specific identification number.

Shortly before the examination can be reviewed by a physician, the virtual marketplace sets an initial interpretation fee for the examination. In one embodiment, the physician's fee for interpreting the examination will be the average market rate for the examination's interpretation. In another embodiment, the physician's fee for interpreting the examination will be established by the virtual marketplace. In the preferred embodiment, the physician's fee for interpreting the examination will be set at the United States' Medicare reimbursement rate.

According to the preferred embodiment, the physician's fee for interpreting the examination will escalate over time until either 1.) a physician decides to interpret the examination, 2.) the primary entity places a “stop order” on the examination's interpretation, or 3.) a predetermined maximum amount for the interpretation fee is reached. In one embodiment, the rate of the increase for the interpretation fee will be dependent upon the time frame in which the interpretation is needed. For instance, the rate of the increase in the fee for the interpretation of an examination that must be read immediately (e.g., less than one hour), will be higher than the rate of the increase in the fee of an examination that must be read in 24 hours and so on.

In one embodiment, the maximum amount that the interpretation fee can rise to is determined by at least two factors. First, the primary entity may place an interpretation fee ceiling or “stop order” on the examination. In this instance, the interpretation fee will rise to a certain predetermined maximum amount and, once the fee rises to that amount, the escalation in the fee will cease. Second, the primary entity may elect to not place a “stop order” on the examination's interpretation fee. Under this scenario, the interpretation fee will rise until the maximum amount or premium price is reached (“the ceiling”).

If a stop order is placed on an examination by a primary entity, and the examination is not selected for interpretation by a physician for a price that is agreeable to the primary entity, an electronic notice is sent to the primary entity. This notice informs the primary entity that the stop order was exercised, and that the examination has not been selected for review by a physician. The primary entity can then elect to send the examination elsewhere or adjust the stop order and resubmit the examination at the virtual marketplace.

At any time after the examination posting can first be reviewed by a physician, until either the stop order level or the ceiling price is reached, any one of the pool of potential physicians may elect to interpret the examination for the current fee. Further, once a physician selects an examination for interpretation at the current price, all other physicians are excluded from interpreting that examination. In the event that no physician takes the case for interpretation, physicians employed by the virtual marketplace will interpret the study. This ensures that every examination without a stop order will be interpreted.

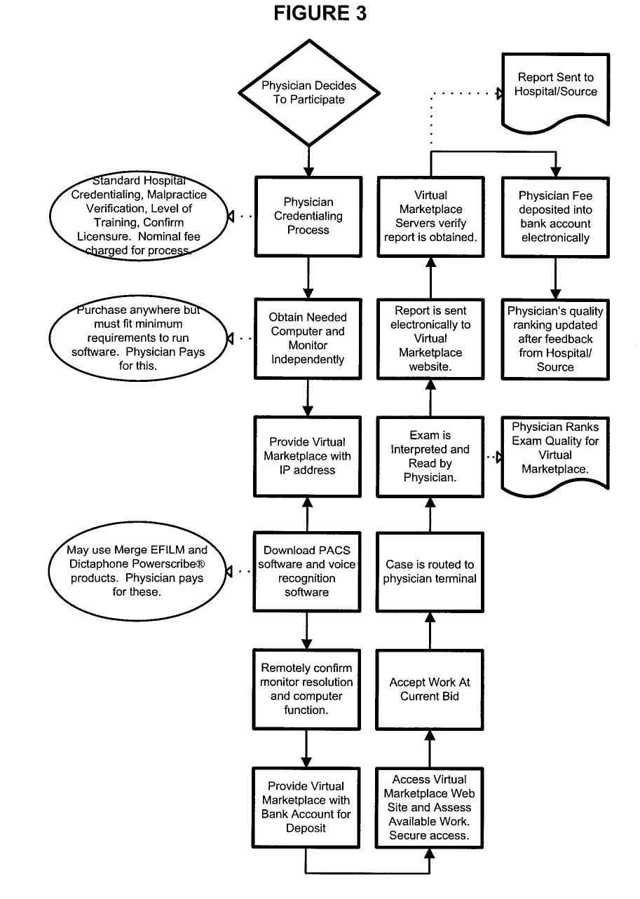

Upon selection by a physician, the examination and the patient information form are routed to the physician's IP address for interpretation. In one embodiment, the physician's computer system will have been evaluated and received prior approval from the virtual marketplace. (See FIG. 3). In the preferred embodiment, a physician's computer system will have been remotely evaluated for its monitor resolution through a series of images that will be sent to him or her for review by the virtual marketplace.

The physician can view the examination using standard PACS software that he or she purchased from the virtual marketplace or from a specified PACS vendor. After the physician has completed the review of the examination, he or she will then prepare that examination's interpretation. In one embodiment, the physician will dictate the interpretation using voice recognition software such as the software sold under the trade name, Powerscribe®. The voice recognition software may be purchased from the virtual marketplace or from a specified software vendor. In another embodiment, the physician will type the interpretation directly into the virtual marketplace. In still another embodiment, the physician will type or hand write the interpretation, and send it to the virtual marketplace via facsimile or mail courier.

Once the physician completes his or her interpretation of the examination, he or she sends the interpretation to the virtual marketplace. In one embodiment, the primary entity receives a communication such as, an e-mail, telephone call, voice message, pager notification, or text message providing that the examination has been interpreted. The virtual marketplace then verifies that the interpretation is complete. In one embodiment, the virtual marketplace establishes minimum review requirements for the interpretation of the examination. These minimum review requirements ensure that the physician is actively analyzing the examination in a reasonable amount of time. For example, the virtual marketplace may set the minimum review requirement for a MRI examination to be at least five minutes.

After verifying that the interpretation is complete, the virtual marketplace then withdraws the interpretation fee for that examination from the primary entity's debit account. As explained above, the interpretation fee can range from the Medicare rate to the ceiling price based on when the physician accepted the examination for interpretation.

A portion of the interpretation fee is then transferred to a direct-deposit account specified by the physician. The remaining portion of the interpretation fee is kept by the virtual marketplace. In one embodiment, the virtual marketplace may keep about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, or 50% of the interpretation fee. In another embodiment, the virtual marketplace may keep about 1 to about 10%, about 10 to about 20%, about 20 to about 30%, about 30 to about 40%, about 40 to about 50%, about 50 to about 60%, about 60 to about 70%, or about 70% to about 80% of the interpretation fee.

Upon receipt of the interpretation fee, the virtual marketplace sends the physician's interpretation to the primary entity. In one embodiment, the virtual marketplace allows the primary entity to rate a physician based on the quality of the medical interpretation and service. In another embodiment, a physician may rate the primary entity based on the quality of its submitted medical diagnostic examinations. In yet another embodiment, the virtual marketplace has the ability to rate both the primary entity and the physician.

In one embodiment, the virtual marketplace allows a primary entity to sort through the medical diagnostic examinations that it has posted at the marketplace using search parameters. These search parameters may include fields, such as: patient name; physician name; or date the examination was performed. In addition, these search parameters may be typed into a search box by the primary entity or, selected by the primary entity using various drop down menus.

In another embodiment, the virtual marketplace temporarily stores the examination, the patient information form, and the interpretation in an archive for at least about 24 hours. In another embodiment, the virtual marketplace temporarily stores the examination, the patient information form, and the interpretation in an archive for at least about 24 hours to at least about 72 hours. In still another embodiment, the virtual marketplace temporarily stores the examination, the patient information form, and the interpretation in an archive for at least about 1 day to at least about 30 days. In yet another embodiment, the virtual marketplace has the ability to store the examination, the patient information form, and the interpretation in an archive indefinitely. In the preferred embodiment, the virtual marketplace deletes the examination, the patient information form, and the interpretation from the archive once the interpretation has been delivered to the primary entity.

In yet another embodiment, the virtual marketplace provides an on-line system for a financial transaction between a hospital, diagnostic imaging center, or medical clinic and a physician, physicians group, or other such entity when contracting for the medical interpretation of these medical diagnostic examinations through the virtual marketplace. In another embodiment, the virtual marketplace provides a medium for the formation and/or execution of a contractual relationship between a hospital, diagnostic imaging center, or medical clinic and a physician, physicians group, or other such entity for the interpretation of medical diagnostic examinations.

In still another embodiment, the present invention creates a free market-type environment in which, through the use of the marketplace, hospitals, diagnostic imaging centers, and medical clinics can reduce their costs for the interpretation of medical diagnostic examinations.

In another embodiment, the present invention provides a method in which prospective consumers (e.g., hospitals, diagnostic imaging centers, and medical clinics) may engage the medical interpretation services of geographically dispersed providers (e.g., physicians, physician groups, or entities employing physicians).

In yet another embodiment, the virtual marketplace functions as a commodities market and utilizes, for example, put options and call options. For example, a physician could place a call option on an examination, providing that he or she will interpret the examination when the interpretation fee reaches a specific price. Further, a primary entity could place a put option on an examination, providing that the examination must be interpreted for a specific interpretation fee.

In another embodiment, the virtual marketplace acts as a national, or global wide area network (“WAN”) linking all participating primary entities and/or secondary entities through the virtual marketplace's servers. For example, the virtual marketplace allows digital examinations to be transferred electronically from one primary entity to the virtual marketplace's servers, and then rerouted to a second primary entity within a matter of hours. In another embodiment, the virtual marketplace allows digital examinations to be transferred electronically from one primary entity to the virtual marketplace's servers and then rerouted to a second primary entity within a matter of minutes. In the preferred embodiment, the transfer occurs within a matter of seconds.

By acting as a WAN, the virtual marketplace affords primary entities, such as, but not limited to, hospitals, the ability to share examinations securely and efficiently, thereby reducing the unnecessary duplication of the examinations. Further, the virtual marketplace affords primary entities the ability to transfer and/or share examinations at any time of the day or night. Thus, primary entities will no longer be limited by the time constraints of couriers or the mail service.

In another embodiment, the virtual marketplace acts as a “bridge.” Examinations are routed through the virtual marketplace's WAN and the virtual marketplace ensures that such data is appropriately directed to the correct end user. The virtual marketplace charges a fee for the transmission of examinations through its servers.

In still another embodiment, examinations may be uploaded to the internet and then on to the virtual marketplace's servers/routers. The examinations may, for example, originate from a hospital archive, diagnostic medical equipment, or patient monitoring devices. The data will then pass through the virtual marketplace's routers and be redirected to the appropriate end user. In yet another embodiment, the virtual marketplace provides a secure bridge whereby all primary or secondary entities maintaining their own medical archives can transfer their examinations across the virtual marketplace's servers to other primary or secondary entities for the purpose of sharing such information.

In yet another embodiment, the virtual marketplace affords primary and secondary entities access to an electronic patient release form. Moreover, the virtual marketplace affords primary and secondary entities access to the virtual marketplace's affiliate listing (e.g., the virtual marketplace's “yellow pages” that lists all current members of the marketplace) so that the entities can designate where the examination should be sent. The examination will then be routed to the correct destination electronically. The virtual marketplace will receive confirmation that the study was transferred, and will bill either the sender or the recipient.

Virtual Physician Consult Service

Under the present invention, the virtual marketplace provides a service which allows unrelated physicians (e.g., physicians which are not practicing at the same hospital or in the same area) located either regionally, nationally, or world-wide to make themselves available to the physician or patient community (either regionally, nationally, or world-wide) by taking on medical consultations. These consultations will be arranged through the virtual marketplace.

In the preferred embodiment, this service will be available through the virtual marketplace and will allow physicians throughout the United States and even abroad to obtain medical consultations from specialist physicians who are remotely located or widely dispersed.

In the preferred embodiment, the service is provided through the virtual marketplace in the following way. First, a physician participating in the virtual marketplace will be given the ability to customize his or her personal profile upon joining the virtual marketplace. In that personal profile, the individual physician will have the ability to determine if he or she will take virtual consultations and, if so, on what topics/disciplines.

Next, a remote physician desiring a consultation about a specific patient can either dial a telephone number, send an e-mail, a text message, log-in into the virtual marketplace's website, or otherwise electronically access the virtual marketplace's website and request a consult about a specific medical topic or patient. By working through a series of menus (available, for example, through either the telephone or the internet), the physician requesting the consultation will define the nature of the medical consultation. The virtual marketplace server or attendant will then query the marketplace physicians who are currently either logged on or working for the virtual marketplace. Those physicians who have the appropriate state licensure to field the consultation, as well as the expertise and willingness (as defined in their personal profile) to field the consultation, will be notified that an opportunity exists to take a medical consultation. In one embodiment, this notification will take the form of a “pop up” on a computer window, a telephone call, an e-mail, a text message, a page, or another type of electronic notification.

If one of the marketplace physicians accepts the medical consultation, the requesting physician's contact information will be forwarded to the consulting physician. In another embodiment, the consulting physician's contact information will be forwarded to the requesting physician. In still another embodiment, the consulting physician and the requesting physician are connected through a virtual chat room. In yet another embodiment, the consulting physician and the requesting physician are connected by dialing in to a conference call telephone line.

The consulting physician will then perform the consultation and provide the requesting physician with the results of the consultation. The consultation will be documented, for example, in a dictated and transcribed report. This report will be forwarded on to the requesting physician and/or a hospital.

In the preferred embodiment, the hospital debit account will have a predetermined consultation fee deducted and then electronically deposited into the account of the consulting physician. In another embodiment, the consultation fee will be paid to the virtual marketplace. In yet another embodiment, the consultation fee will be determined by a bidding process as described below.

In some cases, it may be necessary to schedule a virtual consultation on a specific date or at a future time because the consulting physician may need to review patient studies, clinical notes, laboratory tests, or other pertinent data. Thus, in one embodiment, the virtual marketplace allows the consultation service to be performed on a specific date or at a future time.

In another embodiment, the physician consultation can occur through several media, including, but not limited to, telephone, e-mail, live movie feed, or using instant messenger modes of communication. Information transfer will be in a secure fashion to ensure the safety of patient confidentiality. Further, all laws regarding patient confidentiality and information security will be followed.

3-D Post Processing Lab for Advanced Medical Imaging

Advanced medical imaging, such as CT scanning, MRI imaging, ultrasound, and other modalities make use of advanced computer workstations to “post process” image data. This “post processing” refers to the manipulation of raw image data to generate three-dimensional reconstructions/images of patients. Advanced imaging equipment, such as CT or MRI scanners, are often purchased with a workstation to allow the production of such “post processed” three-dimensional (“3-D”) studies.

However, due to the high cost of advanced workstations to allow post processing of imaging data (e.g., some vendors like Vital Images, TeraRecon, and General Electric cost over $200,000 for the workstation alone) many hospitals elect not to purchase such workstations. Rather, they purchase the CT or MRI scanner but do not obtain a workstation. In addition, because post processing of medical imaging data is a difficult skill to learn, many hospitals do an unsatisfactory job of post processing studies even when they have adequate technical equipment. As a result, many facilities have a difficult time generating 3-D studies for medical review.

The present invention, however, allows for a virtual marketplace with a 3-D post processing laboratory. In one embodiment, the virtual marketplace provides remote image manipulation and post processing services to hospitals, clinics, and imaging center clients. In the preferred embodiment, the post processing service is provided through the virtual marketplace in the following way.

A hospital, clinic, or imaging center with advanced imaging equipment generates the raw image data using medical imaging equipment, such as a CT scanner, MRI scanner, etc. The data is then electronically transmitted to the virtual marketplace by programming an IP address into the imaging equipment (e.g., the CT scanner). Alternatively, the raw imaging data can be sent by mail using, among other things, a CD-ROM or optical disc as a storage medium. In one embodiment, a technologist employed by the virtual marketplace will load the raw data into a computer workstation, generate the requested advanced 3-D images (or in some cases movies) or other requested post processed data, and then electronically transfer or mail the data back to the hospital of origin.

In one embodiment, the post-processing service will be offered at a flat fee per service. In another embodiment, the post-processing service will be offered at an hourly rate.

A number of embodiments of the invention have been described. Nevertheless, it will be understood that various modifications may be made without departing from the spirit and scope of the invention. Accordingly, other embodiments are within the scope of the following claims, and various changes can be made to the above systems, combinations, and methods without departing from the scope of the invention. Further, it is intended that all matter contained in the above description be interpreted as illustrative and not in a limiting sense. All patent documents and references listed herein are incorporated by reference in their entireties.

1. A method operable on a computer for facilitating the interpretation of a medical diagnostic examination between two or more entities through a virtual marketplace, comprising the steps of:
receiving the medical diagnostic examination from a primary entity;
posting the medical diagnostic examination at the virtual marketplace;
allowing a secondary entity to review and interpret the medical diagnostic examination;
providing the primary entity with the secondary entity's interpretation of the medical diagnostic examination; and
compensating the secondary entity for the interpretation.

2. The method of claim 1, wherein the virtual marketplace receives a fee from the primary entity.

3. The method of claim 1, wherein the primary entity and the secondary entity are located in geographically different areas of the world.

4. The method of claim 1, wherein the primary entity and the secondary entity are located at least approximately 30 miles away from each other.

5. A system for interpreting a medical diagnostic examination comprising:
a medical diagnostic examination submission mechanism, whereby the medical diagnostic examination is posted by a primary entity at a virtual marketplace;
a medical diagnostic examination retrieval mechanism, whereby the medical diagnostic examination is retrieved by a secondary entity from the virtual marketplace;
a medical diagnostic examination interpretation mechanism, whereby the medical examination is interpreted by the secondary entity; and
a distribution mechanism whereby the medical diagnostic examination interpretation is delivered to the primary entity.

6. A method operable on a computer for facilitating the interpretation of a medical diagnostic examination between two or more entities through a virtual marketplace, comprising the steps of:
receiving the medical diagnostic examination from a primary entity;
posting the medical diagnostic examination at the virtual marketplace;
setting an initial interpretation fee for the interpretation of the medical diagnostic examination;
increasing the interpretation fee with the passage of time;
allowing a secondary entity to review and interpret the medical diagnostic examination;
providing the primary entity with the secondary entity's interpretation of the medical diagnostic examination; and
compensating the secondary entity for the interpretation.

7. The method of claim 6, wherein the interpretation fee is increased about every 24 hours.

8. The method of claim 6, wherein the interpretation fee is increased about every 60 minutes.

9. The method of claim 6, wherein the interpretation fee is increased about every 30 minutes.

10. The method of claim 6, wherein the interpretation fee is increased until the secondary entity interprets the medical diagnostic examination.

11. The method of claim 6, wherein the interpretation fee is increased until the primary entity places a stop order on the interpretation of the medical diagnostic examination.

12. The method of claim 6, wherein the interpretation fee is increased until a predetermined maximum amount for the interpretation fee is reached.

13. The method of claim 6, wherein the virtual marketplace receives a fee from the primary entity.

14. The method of claim 6, wherein the primary entity and the secondary entity are located in geographically different areas of the United States.

15. The method of claim 6, wherein the primary entity and the secondary entity are located in geographically different areas of the world.

16. The method of claim 6, wherein the primary entity and the secondary entity are located at least approximately 30 miles away from each other.

17. The method of claim 6, wherein the interpretation of the medical diagnostic examination occurs within at least about one week from the posting of the medical diagnostic examination by the primary entity.

18. The method of claim 6, wherein the interpretation of the medical diagnostic examination occurs within at least about 72 hours from the posting of the medical diagnostic examination by the primary entity.

19. The method of claim 6, wherein the interpretation of the medical diagnostic examination occurs within at least about 24 hours from the posting of the medical diagnostic examination by the primary entity.

20. The method of claim 6, wherein the secondary entity is a physician employed by the virtual marketplace.
